(19) United States
(12) Patent Application Publication
(10) Pub. No.: US 2023/0248193 A1
(43) Pub. Date: Aug. 10, 2023

(54) ASSEMBLY FOR THE SUCTION OF DUST

(71) Applicant: BH2M, Belfort (FR)

(72) Inventors: Sébastien BRUNA, Chenebier (FR); Thierry AUZOLLE, Valdoie (FR); Maxime LEGRAND, Belfort (FR)

(73) Assignee: BH2M, Belfort (FR)

(21) Appl. No.: 18/163,452

(22) Filed: Feb. 2, 2023

(30) Foreign Application Priority Data
Feb. 4, 2022 (FR) 2201016

(51) Int. Cl. A47L 7/00; A47L 9/02

(52) U.S. Cl. CPC A47L 7/0057; A47L 9/02

(57) ABSTRACT

An assembly for the suction of dust generated by the friction of an end of a brush on a collector at a contact surface, including at least one suction device and a brush/brush holder assembly, the suction device defines an inner opening to receive the end of the assembly and allow a gaseous passage between the brush/brush holder assembly and the suction device. A gaseous chamber is defined by a tubular wall and extending according to a plane to form a closed ring, the ring defining the inner opening. A collection opening extends longitudinally over a part of the tubular wall intended to face the collector, the collection opening bordered by at least one lip extending from the gaseous chamber in the direction of the inner opening to form a narrow corridor.

### TECHNICAL FIELD

The present invention relates to the field of electromechanical machines, more particularly the field of the devices for suction of dust for brush/collector systems.

### BACKGROUND

In the machines of the electromechanical type, the electric current is transmitted by friction between a fixed part and a mobile part. In general, the systems used include a brush holder fastened onto a fixed part maintaining an electrically conductive brush bearing on a mobile part. The transfer of current takes place at the sliding contact between the brush and the other part (slip ring for example). This sliding engenders the erosion of the brush and the formation of particles of conductive dust that pollute the environment of the system. This conductive dust can by accumulation engender dielectric faults by lowering the insulation distances at certain parts of the machines, and can also damage the bearings or the moving parts on which it is deposited. To prevent this, the operators of these machines put in place maintenance plans aiming to carry out difficult and very tedious cleaning operations. These operations require numerous production stoppages and turn out to be ineffective in removing the totality of the pollution.

To overcome these disadvantages, it is known to use dust collection systems of the nozzle type connected to a suction unit and having a central housing intended to receive the brush so as to suck up the dust generated. This type of system is intended to encapsulate the brush/brush holder. The disadvantage of this type of system is that it can only be used for one particular type of brush/brush holder (because of the dimension of the housing that is congruent with the dimension of the brush/brush holder), it is therefore difficult to integrate into existing machines without replacing certain components. Moreover, to be able to eliminate a large part of the pollution, this type of system must be provided with a suction unit having a large suction power. The effectiveness of this type of system thus remains very limited.

To increase the effectiveness of suction, certain dust collection systems have ducts for blowing air. The blown air creates a gaseous vortex capturing the dust and facilitating its evacuation by suction. However, although more effective, they are rather complicated to put in place since they require a blowing unit and a suction unit as well as several connections to different ducts of the system. Moreover, the power necessary for the evacuation of the dust remains high, which has a significant financial impact, and the system is very noisy during use.

### SUMMARY

The goal of the present invention is to overcome the aforementioned disadvantages by proposing an assembly comprising a device for the suction of dust having a simple configuration, adaptable to several types of brushes/brush holders, having a significant effectiveness of evacuation of the dust without the use of blown air.

According to the invention, an assembly is therefore proposed for the suction of dust generated by the friction of an end of a brush on a collector at a contact surface, comprising at least one suction device and a brush/brush holder assembly, said suction device defining an inner opening adapted to receive the end of the brush/brush holder assembly, and including at least:
a gaseous chamber defined by a tubular wall and extending according to a plane so as to form a closed ring having an overall circular, ovoid or polygonal shape, said ring defining the inner opening,
a collection opening extending longitudinally over a part of the tubular wall intended to face the collector,
a suction duct intended to connect said at least one gaseous chamber to a suction unit,
said suction device being remarkable in that the inner opening is adapted to allow a gaseous passage between said brush/brush holder assembly and said suction device and in that said collection opening is bordered by at least one lip extending from the gaseous chamber in the direction of the inner opening so as to form a narrow corridor.

“Lip” refers to a rim, an extension, a protruding part, which extends from the edge of an opening.

In a first embodiment, the suction device includes several gaseous chambers connected to each other or not, and at least one suction duct connecting said gaseous chambers to at least one suction unit, said gaseous chambers allowing to simultaneously suck up the dust generated by the friction of several brushes on several slip rings.

In a second embodiment, the suction device includes a single gaseous chamber.

Preferably, at least one gaseous passage is a free volume of the inner opening separating the brush/brush holder assembly and the suction device.

Preferably, at least one gaseous chamber extends in the plane so as to have an overall circular, ovoid, rectangular or square shape.

Advantageously, at least one gaseous chamber can be divided into several compartments, each compartment having a suction duct.

Advantageously, at least one collection opening has the shape of a slot that extends along the entire tubular wall on the part of said wall intended to face the collector.

Preferably, the collection opening is bordered by two lips.

Even more preferably, the lip closest to the inner opening called inner lip has a curved profile that ends in a point.

Advantageously, at least one suction duct has a transverse cross-section that has a greater diameter at its junction with the gaseous chamber.

### BRIEF DESCRIPTION OF THE DRAWINGS

Other advantages and features will be clearer from the following description of an alternative embodiment of an assembly for the suction of dust according to the invention in reference to the following drawings:

FIG. 1 is a front view of the assembly according to the invention positioned on a collector;

FIG. 2 is a top view of the suction device of the assembly according to the invention;

FIG. 3 is a transverse cross-sectional view of the suction device of the assembly according to the invention.

### DETAILED DESCRIPTION

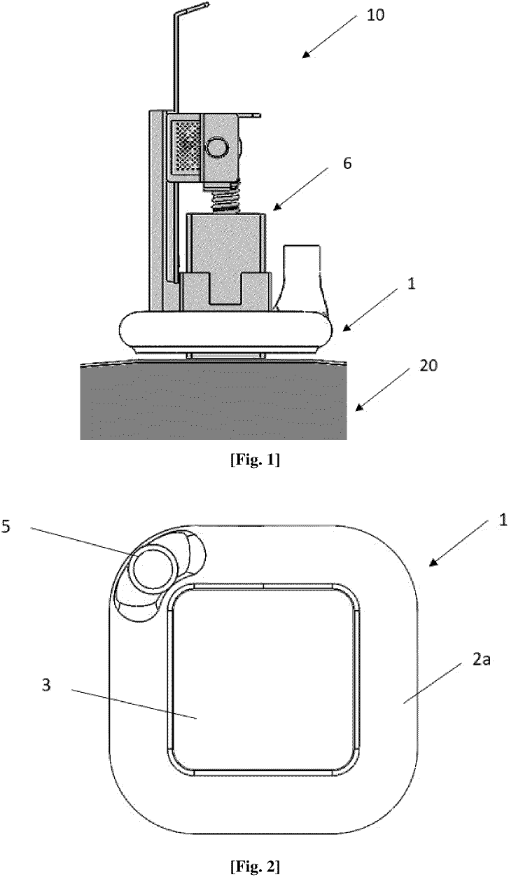

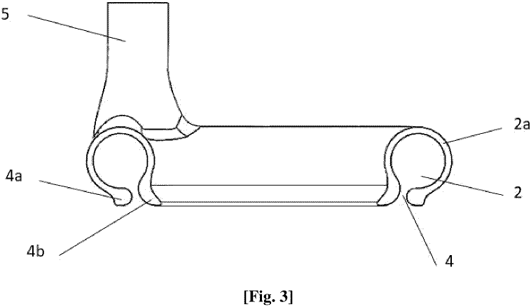

In reference to FIGS. 1 to 3, an assembly 10 is thus proposed for the suction of dust generated by the friction of an end of a brush on a collector 20 at a contact surface, comprising at least one suction device 1 and a brush/brush holder assembly 6, said suction device 1 being remarkable in that it defines an inner opening 3 adapted to receive the end of the brush/brush holder assembly 6 as well as to allow a gaseous passage between said brush/brush holder assembly 6 and said suction device 1, and in that it includes at least:
a gaseous chamber 2 defined by a tubular wall 2a and extending according to a plane so as to form a closed ring having an overall circular, ovoid or polygonal shape, said ring defining the inner opening 3,
a collection opening 4 extending longitudinally over a part of the tubular wall 2a intended to face the collector 20, said collection opening 4 being bordered by at least one lip 4a, 4b extending from the gaseous chamber 2 in the direction of the inner opening 3 so as to form a narrow corridor,
a suction duct 5 intended to connect said at least one gaseous chamber 2 to a suction unit.

In the present application, the term “collector” designates either a set of slip ring(s) also called “slip ring assembly”, or a commutator.

The device 1 is located in the close periphery of the brush/brush holder assembly 6. It surrounds the brush/brush holder assembly 6 without coming in contact directly with it. The inner opening 3 must not form a housing congruent with this assembly, the surface of the opening must allow to receive the brush/brush holder assembly 6 while leaving a gaseous passage between the device 1 and this assembly 6. This gaseous passage is a free space allowing the gas to circulate between the brush/brush holder assembly 6 and the device 1 (thus the brush/brush holder assembly 6 is not encapsulated in the device 1). Gas designates the gas located in the ambient environment of the assembly 6, this can be air or any other gas. In the rest of the description, the case will be considered in which the gas is air.

The starting of the suction unit causes a circulation of air, the ambient air rushes between the brush/brush holder assembly 6 and the device 1, which creates an overpressure in the corridor zone, this overpressure has a “barrier” effect, preventing the dust generated by the brush from spreading. The dust maintained in a zone close to the brush/brush holder assembly 6 is driven by the flow of air and guided via at least one lip 4a, 4b towards the center of the gaseous chamber 2. The curved walls 2a of the gaseous chamber 2 allow this flow to form a vortex, this vortex moves in the chamber 2 up to the suction duct 5. This vortex effect has the advantage of avoiding the dust being deposited inside the device 1 and allowing its guiding towards the suction duct 5 where it is then completely evacuated. The dimensions of the chamber 2, the profile of the lip 4a, 4b, the width of the gaseous passage, the width of the corridor, etc. are chosen according to the speed of sliding or of friction between the brush/brush holder assembly 6 and the collector 20 and the dimensions of this assembly 6. Indeed, in order to obtain the desired suction efficiency, the flow of air generated by the collector 20 must be prevented from disturbing the circulation of air initiated by the suction unit. These choices can be based on digital analyses.

In a transverse cross-section, the tubular wall 2a of the gaseous chamber 2 will have the shape of a circle or an oval open onto the collection opening 4. This curved morphology of the tubular wall 2a allows to prevent the dust sucked up from being deposited thereon.

Because the inner opening 3 does not form a housing congruent with the brush/brush holder assembly 6, the same device 1 can be suitable for several brush/brush holder assemblies 6 of different dimensions.

The fastening of the device 1 is carried out via springs and/or clips and/or fastening lugs. This allows to rapidly install the device 1 on an existing brush holder and also facilitates the maintenance operations (short intervention and thus not costly to install the device 1). This fastening system also has the advantage of allowing to install the device 1 on a brush/brush holder assembly 6 of a machine already operating without having to replace the components (brush/brush holder assembly...) already existing. Moreover, the systems for fastening by springs or clips allow to uncouple the device 1 from the brush/brush holder assembly 6 and thus to avoid transmitting the possible vibrations engendered by the operation of the brush/brush holder assembly 6 to the suction device 1.

The width of the corridor can vary according to the efficiency of the suction desired. This choice must take into account several parameters: speed of the collector 20, material of the brushes (the dust generated will have a different size according to the material of the brush), power of the suction unit, etc. This width is preferably chosen in a range of values between 1 and 12 mm. Even more preferably, between 1 and 10 mm. This corridor allows to distribute the “barrier” effect all around the chamber 2, regardless of the position of the suction duct 5. This has the advantage of being able to dispose the suction duct 5 anywhere at the chamber 2, which allows to adapt the device 1 to any type of machine.

The at least one collection opening 4 extends longitudinally over the entire tubular wall 2a, that is to say longitudinally over the entire length of the chamber 2 while following the general shape of the latter. The collection opening 4 can be a set of several openings disposed nearby while following the length of the chamber 2 or a single opening over the entire length of the chamber 2. A collection opening 4 in a single opening has the advantage of a homogenous distribution of the suction force and thus a circulation of air all around the brush/brush holder assembly 6.

Advantageously, the gaseous passage is equipped with one or more deflectors. These deflectors have the advantage of channeling the flow of air circulating in the gaseous passage between the device 1 and the brush/brush holder assembly 6. The use of deflectors allows to control the angle of incidence of the flow of air with the sliding surface (contact surface between the brush and the collector 20). These deflectors can be used for example to advantageously modify the outer surface of the brush/brush holder assembly 6 so as to optimize the circulation of air at the gaseous passage. This angle plays a role in the creation of the “barrier” effect.

In a first embodiment, the suction device 1 includes several gaseous chambers 2 connected to each other or not, and at least one suction duct 5 connecting said gaseous chambers 2 to at least one suction unit, said gaseous chambers 2 allowing to simultaneously suck up the dust generated by the friction of several brushes on several slip rings 20. This type of device 1 allows to handle the suction of the dust generated by several nearby brush/brush holder assemblies 6. One or more suction ducts 5 are distributed on the device 1. If the suction power is not sufficient, it is possible to compartmentalize the various chambers 2, and to connect the various compartments to a suction unit.

In a second embodiment, the suction device 1 includes a single gaseous chamber 2. In this embodiment, the device 1 is adapted to suck up the dust generated by a brush/brush holder assembly 6. It is also possible to dimension the device 1 so that it houses in its inner opening 3 several brush/brush holder assemblies 6.

Preferably, at least one gaseous passage is a free volume of the inner opening 3 separating the brush/brush holder assembly 6 and the suction device 1.

Preferably, at least one gaseous chamber 2 extends in the plane so as to have an overall circular, ovoid, rectangular or square shape. For the shapes having angles, the latter are preferably rounded in order to facilitate the circulation of gas. The overall shape and the dimensions of the gaseous chamber 2 are preferably chosen according to the shape and the dimensions of the brush/brush holder assembly 6. The device 1 is preferably made of polymer materials but it can also be manufactured from any material suitable for the desired use. Because of its complex shape, the device 1 is preferably made by molding, blowing or a three-dimensional printing method. The material chosen is preferably electrically insulating and allows to ensure good operation of the system in the conditions of temperature and of mechanical stresses of the machine. Glass fiber reinforced polyamide has the mechanical and thermal characteristics satisfying these conditions and also has the advantage of being able to be implemented via a three-dimensional printing method such as laser sintering.

Advantageously, at least one gaseous chamber 2 can be divided into several compartments, each compartment having a suction duct 5. This allows to concentrate the same suction power over a smaller space (compartment rather than entire chamber) and thus to increase the barrier effect. It is also possible to choose to connect certain compartments and not others to a suction unit according to the needs, by connecting the suction duct 5 of the compartment to a suction unit or not. In the case of a device 1 including a single chamber 2 adapted to receive several brush/brush holder assemblies 6, this chamber 2 can be compartmentalized to increase the suction power (and thus the barrier effect) and ensure a more effective suction.

Advantageously, at least one collection opening 4 has the shape of a slot that extends along the entire tubular wall 2a over the part of said wall 2a intended to face the collector 20. The collection opening extends along the entire tubular wall and follows the contour thereof. In the case of a gaseous chamber in the shape of a circular ring, the opening 4 is a circle. This opening 4 is on the part of the tubular wall 2a intended to face the collector 20 so as to be as close as possible to the zone of formation of the dust. The collection opening 4 can however take any other shape adapted to the use: several slots disposed longitudinally along the entire tubular wall, circular openings, etc. The collection opening 4 extends longitudinally over the entire tubular wall 2a, that is to say longitudinally over the entire length of the chamber 2 while following the overall shape of the latter. This has the advantage of a homogenous distribution of the suction force and thus a circulation of air all around the brush/brush holder assembly 6.

More advantageously, the collection opening 4 is bordered by two lips 4a, 4b. These two lips 4a, 4b are formed on the edges of the slot (each lip extends an edge) and allow the formation of a narrow corridor that extends the gaseous chamber. At the least, one of these lips 4a, 4b is oriented towards the inner opening 3. Whether the device has one or two lips 4a, 4b, the angle formed between at least one lip 4a, 4b and the plane defined by the contact surface between the brush and the collector 20 is substantially between 15 and 80°. Preferably, this angle is between 20 and 75°. This angle can be different at various locations of the lip 4a, 4b along the entire gaseous chamber 2. The choice of angle is made according to the conditions of rotation of the collector 20.

Even more advantageously, the lip 4b closest to the inner opening 3 called inner lip 4b has a curved profile that ends in a point.

Each of the lips 4a, 4b can have a different profile. The curved morphology of the inner lip 4b facilitates the circulation of air coming from the inner opening 3, by minimizing the head losses.

Preferably, the other lip 4a opening onto the exterior of the device can have a more bulging profile and end in a profile that flattens according to a plane parallel to the sliding surface (contact surface between the brush and the collector). This allows to create a significant head loss and to prevent the dust from escaping. This flattened part advantageously extends over several millimeters according to a plane parallel to the sliding surface.

Preferably, the device 1 is placed at a distance of between 1 and 3 mm from the collector 20. This distance allows to avoid coming in contact with the collector 20 in rotation while ensuring suction as close as possible to the zone of generation of the dust.

Advantageously, at least one suction duct 5 has a transverse cross-section that has a greater diameter at its junction with the gaseous chamber 2.

Even more advantageously, at least one suction duct 5 is positioned on the chamber 2 opposite to the lips 4a, 4b and to the collection opening 4.

The invention also relates to a device 1 for suction of dust generated by the friction of an end of a brush on a collector 20 remarkable in that it includes at least:
a gaseous chamber 2 defined by a tubular wall 2a and extending according to a plane so as to form a closed ring having an overall circular, ovoid or polygonal shape, said ring defining the inner opening 3,
a collection opening 4 extending longitudinally over a part of the tubular wall 2a intended to face the collector 20, said collection opening 4 being bordered by at least one lip 4a, 4b extending from the gaseous chamber 2 in the direction of the inner opening 3 so as to form a narrow corridor,
a suction duct 5 intended to connect said at least one gaseous chamber 2 to a suction unit.

Several tests show that the suction device 1 and the assembly 10 according to the invention are particularly effective. Indeed, for a sliding speed of 10 m.s-1, the suction power necessary for 40 brush/brush holder assemblies is 3 kW and the suction effectiveness exceeds 80%.

The effectiveness of this suction device is not linked to its physical proximity to the brush/brush holder assembly 6 but to its capacity to guide the circulation of the air.

The assembly 10 according to the invention has a particular use in the industry of electromechanical machines for evacuating the dust generated by the friction of components of the brush/collector 20 type for example, but it can also be used for other types of components. Finally, it goes without saying that the examples of assemblies according to the invention that have just been described are only particular illustrations, in no case limiting to the invention.

1. An assembly for the suction of dust generated by the friction of an end of a brush on a collector at a contact surface, comprising: at least one suction device and a brush/brush holder assembly, said suction device defining an inner opening adapted to receive the end of the brush/brush holder assembly, and including at least:
a gaseous chamber defined by a tubular wall and extending according to a plane so as to form a closed ring having an overall circular, ovoid or polygonal shape,
said ring defining the inner opening,
a collection opening extending longitudinally over a part of the tubular wall intended to face the collector, and
a suction duct intended to connect said at least one gaseous chamber to a suction unit,
wherein the inner opening is adapted to allow a gaseous passage between said brush/brush holder assembly and said suction device and said collection opening is bordered by at least one lip extending from the gaseous chamber in the
direction of the inner opening so as to form a narrow corridor.

2. The assembly according to claim 1, wherein the suction device includes several gaseous chambers connected to each other or not, and at least one suction duct connecting said gaseous chambers to at least one suction unit, said gaseous chambers allowing to simultaneously suck up the dust generated by the friction of several brushes on several slip rings.

3. The assembly according to claim 1, wherein the suction device includes a single gaseous chamber.

4. The assembly according to claim 1, wherein at least one gaseous passage is a free volume of the inner opening separating the brush/brush holder assembly and the suction device.

5. The assembly according to claim 1, wherein at least one gaseous chamber extends in the plane so as to have an overall circular, ovoid, rectangular or square shape.

6. The assembly according to claim 1, wherein at least one gaseous chamber can be divided into several compartments, each compartment having a suction duct.

7. The assembly according to claim 1, wherein at least one collection opening has the shape of a slot that extends along the entire tubular wall on the part of said wall intended to face the collector.

8. The assembly according to claim 7, wherein the collection opening is bordered by two lips.

9. The assembly according to claim 8, wherein the lip closest to the inner opening called inner lip has a curved profile that ends in a point.

10. The assembly according to claim 1, wherein at least one suction duct has a transverse cross-section that has a greater diameter at its junction with the gaseous chamber.
